(19) United States
(12) Patent Application Publication
(10) Pub. No.: US 2020/0301190 A1
(43) Pub. Date: Sep. 24, 2020

(54) COLOR RESIST SUBSTRATE AND LIQUID CRYSTAL DISPLAY PANEL

(71) Applicant: WUHAN CHINA STAR OPTOELECTRONICS TECHNOLOGY CO., LTD., Wuhan, Hubei (CN)

(72) Inventor: Fengzhu AI, Wuhan Hubei (CN)

(21) Appl. No.: 16/340,118

(22) PCT Filed: Feb. 19, 2019
(86) PCT No.: PCT/CN2019/075420

§ 371 Date: Apr. 7, 2019

(30) Foreign Application Priority Data
Nov. 27, 2018 (CN) 201811422614.3

(51) Int. Cl. G02F 1/1339; G02F 1/1335

(52) U.S. Cl. CPC G02F 1/13394; G02F 1/133512; G02F 1/133514

(57) ABSTRACT

A color resist substrate and a liquid crystal display panel are provided and include a base substrate, a black matrix formed on the base substrate, an insulation layer formed in grooves, and a light shielding layer formed on the insulation layer. The grooves are defined through an edge region of the black matrix. The light shielding layer covers the grooves. By disposing the light shielding layer, light leakage on an edge of the display panel can be effectively mitigated to improve display quality.

### FIELD OF INVENTION

The present invention relates to a field of display technologies, especially to a color resist substrate and a liquid crystal display panel.

### BACKGROUND OF INVENTION

A conventional liquid crystal display (LCD) panel generally includes a color resist substrate and an array substrate disposed oppositely and a liquid crystal layer disposed between the two substrates. A black matrix is disposed on a side of the color resist substrate, and is configured to shield leaked light. However, the black matrix has certain electrical conductivity. To increase antistatic capability of the liquid crystal display (LCD) panel to electro static discharge (ESD), a black matrix located in a non-displaying region of the LCD panel is cut to define several grooves through the black matrix to prevent the black matrix from transferring static electricity from the non-displaying region of the LCD panel to a displaying region and causing display errors due to the static electricity.

To shield light leakage in the grooves, a main technology of prior art generally fills a single color resist or a multi-color resist stacked with a plurality of color resist blocks into the grooves for light shielding purpose. Because the non-displaying region of the LCD panel is disposed with a driver circuit therein, an electrical field driving liquid crystal molecules in the liquid crystal layer to rotate is inevitably generated. Under the effect of the electrical field, the liquid crystal molecules rotate to drive backlight emitting toward the non-displaying region of the LCD panel to reach the color resist substrate. The color resist blocks filled in the grooves have a certain light transmittance and cannot absolutely shield light. After light extends out through the color resist blocks, a light line appears on an edge of the LCD panel to affect displaying quality of the LCD panel.

### SUMMARY OF INVENTION

The present invention provides a color resist substrate and a liquid crystal display panel to solve the technical issue that a black matrix at an edge region of a color resist substrate of the conventional liquid crystal display panel is defined with grooves to increase antistatic capability of panel, and, to shield leaked light in grooves, the grooves are filled with color resist, but the color resist performs poor light shielding function and causes light lines at the edge of the panel to influence displaying quality of the panel.

To solve the above issue, the present invention provides technical solutions as follows.

The present invention provides a color resist substrate, comprising: a base substrate; a color resist layer formed on the base substrate; a black matrix formed on the base substrate, and grooves defined through an edge region of the black matrix; an insulation layer formed in the grooves; and a light shielding layer formed on the insulation layer; wherein the light shielding layer covers the grooves, a surface of the light shielding layer facing away from the base substrate is higher than a surface of the black matrix facing away from the base substrate, and the insulation layer and the color resist layer are formed by a same mask process.

In at least one embodiment of the present invention, the light shielding layer comprises a first sub-light shielding layer and a second sub-light shielding layer disposed on a surface of the insulation layer and located adjacent to each other.

In at least one embodiment of the present invention, a height of the first sub-light shielding layer is greater than a height of the second sub-light shielding layer.

In at least one embodiment of the present invention, orthographic projections of the first sub-light shielding layer and the second sub-light shielding layer on the base substrate cover orthographic projections of the grooves on the base substrate.

In at least one embodiment of the present invention, a side surface of the insulation layer facing away from the base substrate is parallel with the base substrate.

In at least one embodiment of the present invention, the insulation layer is filled into the grooves.

In at least one embodiment of the present invention, the side surface of the insulation layer facing away from the base substrate is higher than a depth of the grooves.

The present invention also provides a color resist substrate, comprising: a base substrate; a black matrix formed on the base substrate, and grooves defined through an edge region of the black matrix; an insulation layer formed in the grooves; and a light shielding layer formed on the insulation layer; wherein the light shielding layer covers the grooves.

In at least one embodiment of the present invention, a surface of the light shielding layer facing away from the base substrate is higher than a surface of the black matrix facing away from the base substrate.

In at least one embodiment of the present invention, the light shielding layer comprises a first sub-light shielding layer and a second sub-light shielding layer disposed on a surface of the insulation layer and located adjacent to each other.

In at least one embodiment of the present invention, wherein a height of the first sub-light shielding layer is greater than a height of the second sub-light shielding layer.

In at least one embodiment of the present invention, orthographic projections of the first sub-light shielding layer and the second sub-light shielding layer on the base substrate cover orthographic projections of the grooves on the base substrate.

In at least one embodiment of the present invention, a side surface of the insulation layer facing away from the base substrate is parallel with the base substrate.

In at least one embodiment of the present invention, the insulation layer is filled into the grooves.

In at least one embodiment of the present invention, the side surface of the insulation layer facing away from the base substrate is higher than a depth of the grooves.

The present invention also provides a liquid crystal display panel, comprising an array substrate and a color resist substrate disposed opposite to each other and a liquid crystal layer disposed between the array substrate and the color resist substrate, wherein the color resist substrate comprises: a base substrate; a black matrix formed on a side of the base substrate close to the liquid crystal layer, and grooves defined through an edge region of the black matrix; an insulation layer formed in the grooves; and a light shielding layer formed on the insulation layer; wherein the light shielding layer covers the grooves.

In at least one embodiment of the present invention, the light shielding layer comprises a first sub-light shielding layer and a second sub-light shielding layer disposed adjacent to each other, and a height of the first sub-light shielding layer is greater than a height of the second sub-light shielding layer.

In at least one embodiment of the present invention, orthographic projections of the first sub-light shielding layer and the second sub-light shielding layer on the base substrate cover orthographic projections of the grooves on the base substrate.

In at least one embodiment of the present invention, a side surface of the insulation layer facing away from the base substrate is parallel with the base substrate.

In at least one embodiment of the present invention, the insulation layer is filled into the grooves.

Advantages of the present invention are as follows. The color resist substrate and the liquid crystal display panel provided by the present invention, by disposing the light shielding layer, can effectively mitigate light leakage issue at the edge of the display panel to improve displaying quality. Furthermore, the light shielding layer can maintain a certain height, and can perform buffering function during a display panel cutting process to prevent rupture of the glass substrate. Moreover, the light shielding layer can be manufactured with other films without an additional manufacturing process.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic structural view of a color resist substrate of the present invention;

FIG. 2 is another schematic structural view of the color resist substrate of the present invention; and

FIG. 3 is a schematic structural view of a liquid crystal display panel of the present invention.

### DETAILED DESCRIPTION OF PREFERRED EMBODIMENTS

Each of the following embodiments is described with appending figures to illustrate specific embodiments of the present invention that are applicable. The terminologies of direction mentioned in the present invention, such as “upper”, “lower”, “front”, “rear”, “left”, “right”, “inner”, “outer”, “side surface”, etc., only refer to the directions of the appended figures. Therefore, the terminologies of direction are used for explanation and comprehension of the present invention, instead of limiting the present invention. In the figures, units with similar structures are marked with the same reference characters.

The present invention aims at the technical issue that a black matrix at an edge region of a color resist substrate of the conventional liquid crystal display (LCD) panel is defined with grooves to increase antistatic capability of panel, and, to shield leaked light in grooves, the grooves are filled with color resist, but the color resist performs poor light shielding function and causes light lines at the edge of the panel to influence displaying quality of the panel. The present invention can solve the technical issue.

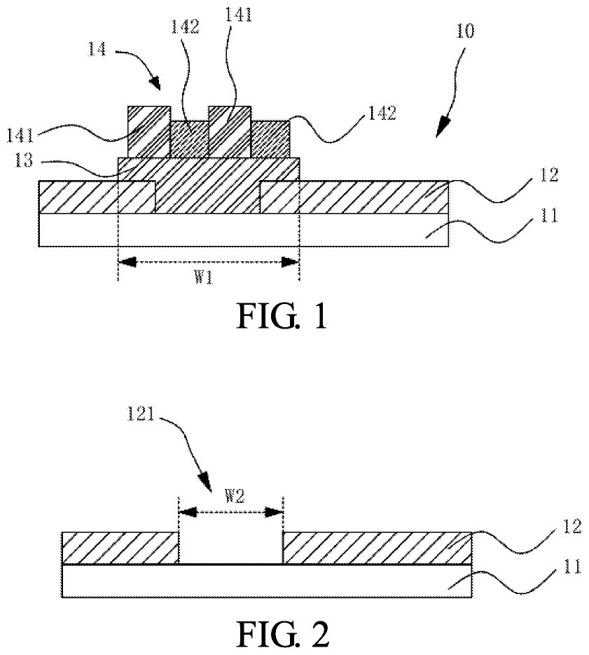

With reference to FIGS. 1 and 2, the present invention provides a color resist substrate 10 including a base substrate 11, a black matrix 12 disposed on the base substrate 11, an insulation layer 13, and a light shielding layer 14.

An edge region of the black matrix 12 is defined with grooves 121 extending through the black matrix 12. A number of the grooves 121 depend on a width of a non-displaying region when the color resist substrate 10 is applied to the display panel. The present embodiment takes one of the grooves as an example, the groove 121 is configured to prevent external static electricity from entering and prohibit the static electricity from causing display errors.

The insulation layer 13 is formed in the grooves 121, the light shielding layer 14 is formed on the insulation layer 13, the insulation layer 13 cover the grooves 121.

The insulation layer 13 is filled into the grooves 121, a side surface of the insulation layer 13 facing away from the base substrate 11 is parallel with the base substrate 11, the insulation layer not only performs insulation function to prevent the static electricity from entering but also provides a flat surface for the light shielding layer 14.

To provide a better insulation effect, the side surface of the insulation layer 13 facing away from the base substrate 11 can be higher than a depth of the grooves 121. A width W1 of a portion of the insulation layer 13 higher than the grooves 121 can be greater than a width W2 of the grooves 121 such that the insulation layer 13 can provide a shielding area for the light shielding layer 14 and achieve a better shielding effect.

Material of the insulation layer 13 can be a blue color resist, and can be a red or green color resist. The color resist substrate 10 also includes red, green and blue color resist layers. During manufacturing of the insulation layer 13, a same mask process applied to the color resist layer of the color resist substrate 10 can also be applied thereto without an additional mask process, which simplifies manufacturing procedures.

The light shielding layer 14 includes a first sub-light shielding layer 141 and a second sub-light shielding layer 142 disposed on a surface of the insulation layer. The first sub-light shielding layer and the second sub-light shielding layer 142 are located adjacent to each other. A number of each of the first sub-light shielding layer 141 and the second sub-light shielding layer 142 can be plural. In the present embodiment, the number of each of the first sub-light shielding layer 141 and the second sub-light shielding layer 142 is two, and orthographic projections of all the first sub-light shielding layers 141 and the second sub-light shielding layers 142 on the base substrate 11 jointly cover orthographic projections of the grooves 121 on the base substrate 11.

A height of the first sub-light shielding layer 141 is greater than a height of the second sub-light shielding layer 142. A width of the first sub-light shielding layer is greater than a width of the second sub-light shielding layer 142. One second sub-light shielding layer 142 is disposed between two first sub-light shielding layers 141.

When the color resist substrate 10 is applied to the LCD panel, the first sub-light shielding layer 141 and the second sub-light shielding layer 142, mitigates the issue of light leakage of the display panel and prevents rupture of an edge of a glass substrate (generally a base substrate employs a glass substrate) during cutting of the display panel. Because during cutting of the display panel, the light shielding layer 14 is squeezed, if the height of the light shielding layer 14 is set to be equal to a height of the first sub-light shielding layer 141, density of the light shielding layer 14 will become excessive and will perform overly strong supporting force, which will cause rupture of the edge of the glass. Therefore, the present invention divides the light shielding layer 14 into the first sub-light shielding layer 141 and the second sub-light shielding layer 142 with different heights such that the density of the light shielding layer 14 can be decreased to lower risk of rupture of the display panel.

The first sub-light shielding layer 141 and the second sub-light shielding layer 142 are manufactured by black photo sensitive material. During manufacturing, the first sub-light shielding layer 141 and the second sub-light shielding layer 142 are manufactured simultaneously with main photo spacers and sub-photo spacers in a displaying region of the display panel without any additional process.

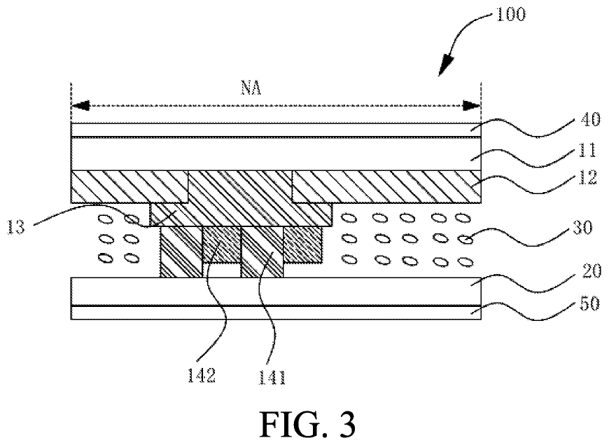

With reference to FIGS. 1 to 3, the present invention also provides a LCD panel 100 that is defined with a displaying region and a non-displaying region NA disposed around the displaying region, and comprises an array substrate 20, a liquid crystal layer 30, and the color resist substrate 10 of the abovementioned embodiment.

The color resist substrate 10 and the array substrate 20 are disposed opposite to each other. The liquid crystal layer 30 is disposed between the array substrate 20 and the color resist substrate 10.

The LCD panel 100 further includes a lower polarizer 50 disposed on a side of the array substrate 20 facing away from the liquid crystal layer 30 and an upper polarizer 40 disposed on a side of the color resist substrate 10 facing away from the liquid crystal layer 30.

The color resist substrate 10 includes a base substrate 11, a black matrix 12, an insulation layer 13, a light shielding layer 14, and red, green and blue color resist layers (not shown in the figures) disposed in the displaying region.

The black matrix 12 is disposed on a side of the base substrate 11 close to the liquid crystal layer 30. Grooves 121 defined through an edge region (located in the non-displaying region NA) of the black matrix 12.

The insulation layer 13 is formed in the grooves 121. The light shielding layer 14 is formed on the insulation layer 13. The insulation layer 13 covers the grooves 121.

The light shielding layer 14 includes a first sub-light shielding layer 141 and a second sub-light shielding layer 142 disposed on a surface of the insulation layer. The first sub-light shielding layer 141 and the second sub-light shielding layer 142 are located adjacent to each other. Orthographic projections of the first sub-light shielding layer 141 and the second sub-light shielding layer 142 on the base substrate 11 jointly cover orthographic projections of the grooves on the base substrate 11. A height of the first sub-light shielding layer 141 is greater than a height of the second sub-light shielding layer 142.

Material of the insulation layer 13 can be a blue color resist, and can be a red or green color resist. The color resist substrate 10 also includes red, green and blue color resist layers. During manufacturing of the insulation layer 13, a same mask process applied to the color resist layer of the color resist substrate 10 can also be applied thereto without an additional mask process, which simplifies manufacturing procedures.

The first sub-light shielding layer 141 and the second sub-light shielding layer 142 are manufactured with black photo sensitive material. During manufacturing, the first sub-light shielding layer 141 and the second sub-light shielding layer 142 are manufactured simultaneously with main photo spacers (Main PS) and sub-photo spacers (Sub PS) in the displaying region the of the display panel by a same process without any additional process.

Specific structures of the color resist substrate 10 can refer to details of the abovementioned embodiment and will not be described repeatedly herein.

Advantages: The color resist substrate and the LCD panel provided by the present invention, by disposing the light shielding layer, can effectively mitigate light leakage at the edge of the display panel to improve displaying quality. Furthermore, the light shielding layer can maintain a certain height and can perform a buffering function during the display panel cutting process to prevent rupture of glass substrate. Moreover, the light shielding layer can be manufactured with other films without an additional manufacturing process.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

1. A color resist substrate, comprising:
a base substrate;
a black matrix formed on the base substrate, and grooves defined through an edge region of the black matrix;
an insulation layer formed in the grooves; and
a light shielding layer formed on the insulation layer and located at a position corresponding to the edge region of the black matrix;
wherein the light shielding layer covers the grooves, and a surface of the light shielding layer facing away from the base substrate is higher than a surface of the black matrix facing away from the base substrate
wherein the light shielding layer comprises a first sub-light shielding layer and a second sub-light shielding layer disposed on a surface of the insulation layer and located adjacent to each other.

2. (canceled)

3. The color resist substrate as claimed in claim 1, wherein a height of the first sub-light shielding layer is greater than a height of the second sub-light shielding layer.

4. The color resist substrate as claimed in claim 3, wherein orthographic projections of the first sub-light shielding layer and the second sub-light shielding layer on the base substrate cover orthographic projections of the grooves on the base substrate.

5. The color resist substrate as claimed in claim 1, wherein a side surface of the insulation layer facing away from the base substrate is parallel with the base substrate.

6. The color resist substrate as claimed in claim 5, wherein the insulation layer is filled into the grooves.

7. The color resist substrate as claimed in claim 6, wherein the side surface of the insulation layer facing away from the base substrate is higher than a depth of the grooves.

8. A color resist substrate, comprising:
a base substrate;
a black matrix formed on the base substrate, and grooves defined through an edge region of the black matrix;
an insulation layer formed in the grooves; and
a light shielding layer formed on the insulation layer and located at a position corresponding to the edge region of the black matrix;
wherein the light shielding layer covers the grooves;
wherein the light shielding layer comprises a first sub-light shielding layer and a second sub-light shielding layer disposed on a surface of the insulation layer and located adjacent to each other.

9. The color resist substrate as claimed in claim 8, wherein a surface of the light shielding layer facing away from the base substrate is higher than a surface of the black matrix facing away from the base substrate.

10. (canceled)

11. The color resist substrate as claimed in claim 8, wherein a height of the first sub-light shielding layer is greater than a height of the second sub-light shielding layer.

12. The color resist substrate as claimed in claim 11, wherein orthographic projections of the first sub-light shielding layer and the second sub-light shielding layer on the base substrate cover orthographic projections of the grooves on the base substrate.

13. The color resist substrate as claimed in claim 8, wherein a side surface of the insulation layer facing away from the base substrate is parallel with the base substrate.

14. The color resist substrate as claimed in claim 13, wherein the insulation layer is filled into the grooves.

15. The color resist substrate as claimed in claim 14, wherein the side surface of the insulation layer facing away from the base substrate is higher than a depth of the grooves.

16. A liquid crystal display (LCD) panel, comprising an array substrate and a color resist substrate disposed opposite to each other and a liquid crystal layer disposed between the array substrate and the color resist substrate, wherein the color resist substrate comprises:
a base substrate;
a black matrix formed on a side of the base substrate close to the liquid crystal layer, and grooves defined through an edge region of the black matrix;
an insulation layer formed in the grooves; and
a light shielding layer formed on the insulation layer and located at a position corresponding to the edge region of the black matrix;
wherein the light shielding layer covers the grooves;
wherein the light shielding layer comprises a first sub-light shielding layer and a second sub-light shielding layer disposed adjacent to each other.

17. The LCD panel as claimed in claim 16, wherein a height of the first sub-light shielding layer is greater than a height of the second sub-light shielding layer.

18. The LCD panel as claimed in claim 17, wherein orthographic projections of the first sub-light shielding layer and the second sub-light shielding layer on the base substrate cover orthographic projections of the grooves on the base substrate.

19. The LCD panel as claimed in claim 16, wherein a side surface of the insulation layer facing away from the base substrate is parallel with the base substrate.

20. The color resist substrate as claimed in claim 16, wherein the insulation layer is filled into the grooves.
